(19) United States
(12) Patent Application Publication
(10) Pub. No.: US 2014/0115949 A1
(43) Pub. Date: May 1, 2014

(54) STABILIZED FISH BASKET

(71) Applicant: Bill Whitehead, Davison, MI (US)

(72) Inventor: Bill Whitehead, Davison, MI (US)

(21) Appl. No.: 13/664,483

(22) Filed: Oct. 31, 2012

(51) Int. Cl. A01K 97/20

(52) U.S. Cl. CPC A01K 97/20
USPC 43/55

(57) ABSTRACT

A stabilized fish basket, wherein the stabilized fish basket comprises a metal wire mesh enclosure having essentially a cage-like structure. The cage-like structure has a portion near one end that is extended above said cage-like structure but is unitary with the cage-like structure. The extended portion has an open top. There is a mounting structure fixedly attached to one side of the cage-like structure wherein the mounting structure comprises a metal framework containing an attachment bracket for attaching the stabilized fish basket to an oarlock on a boat.

### BACKGROUND OF THE INVENTION

Fish receptacles for retaining caught fish and keeping them in a live and fresh condition are many. For example, U.S. Pat. No. 4,570,374 to Baxley, deals with a floating fish receptacle that has a floatation collar to suspend a net or mesh cage beneath the water. The device is free floating in the water. U.S. Pat. No. 4,703,577 to Gubesh deals with a similar device in which there is a buoyancy device for collapsible mesh fish baskets. The device floats freely in the water. U.S. Pat. No. 4,858,372 to Ray deals with another type of floating fish basket and U.S. Pat. No. 5,412,903 deals with a sea cage used in fish farming systems. All of these devices are free floating and suffer from the fact that they have a covering over the basket that has to be removed prior to putting in the fish, or they collapse when raised from the water and placed on a solid substrate.

U.S. Pat. No. 4,429,659 deals with an apparatus and method of confining fish in which there is used a fish case. This cage is intended to freely float in the water. U.S. Pat. Nos. 6,105,305; 5,299,530, and, 5,632,114 all deal with traps or the like which are used underwater, essentially on the bottom of the water.

U.S. Pat. No. 6,267,079 to Eby deals with a fish cage that is constructed similar to the device of the instant invention in that it uses a metal mesh to form a cage-like structure. However, this device does not have the essential components to provide a useful stabilized fish basket as taught in the instant invention.

### THE INVENTION

The present invention deals with a stabilized fish basket, wherein the stabilized fish basket comprises a metal wire mesh enclosure having essentially a cage-like structure with a top, bottom, front side, back side, and two ends.

The cage-like structure has a portion near one end that is extended above said cage-like structure but is unitary with the cage-like structure. The extended portion has an open top. There is a mounting structure fixedly attached to one side of the cage-like structure wherein the mounting structure comprises a metal framework consisting of a bottom rail, two side rails, and a cross member rail forming a top rail.

The top rail has mounted on it, near the center, an attachment bracket for attaching the cage-like structure to an oar lock receptacle on a boat. The attachment bracket consists of a housing having a top and a bottom, there being aligned openings through the top and bottom through which there is inserted an oar lock having a retainer pin for retaining the oar lock in the oar lock receptacle. Each side rail has an adjustable stand-off rod mounted in it for holding the cage-like structure essentially vertical along the side of a boat.

### BRIEF DESCRIPTION OF THE DRAWINGS

FIG. 1 is a full side view of a device of this invention showing the mounting bracket on the opposite side of the device.

FIG. 2 is a full side view of the device of FIG. 1, showing the full view of the mounting bracket.

FIG. 3 is a full end view of the device of FIG. 1, showing the mounting bracket and its component parts in more detail.

FIG. 4 is a full view of the detail of the attachment bracket of the device of this invention.

FIG. 5 is a view of a portion of a boat showing the oarlock and the arrangement of the mounting bracket in the oarlock and on the boat side.

### DETAILED DESCRIPTION OF THE DRAWINGS

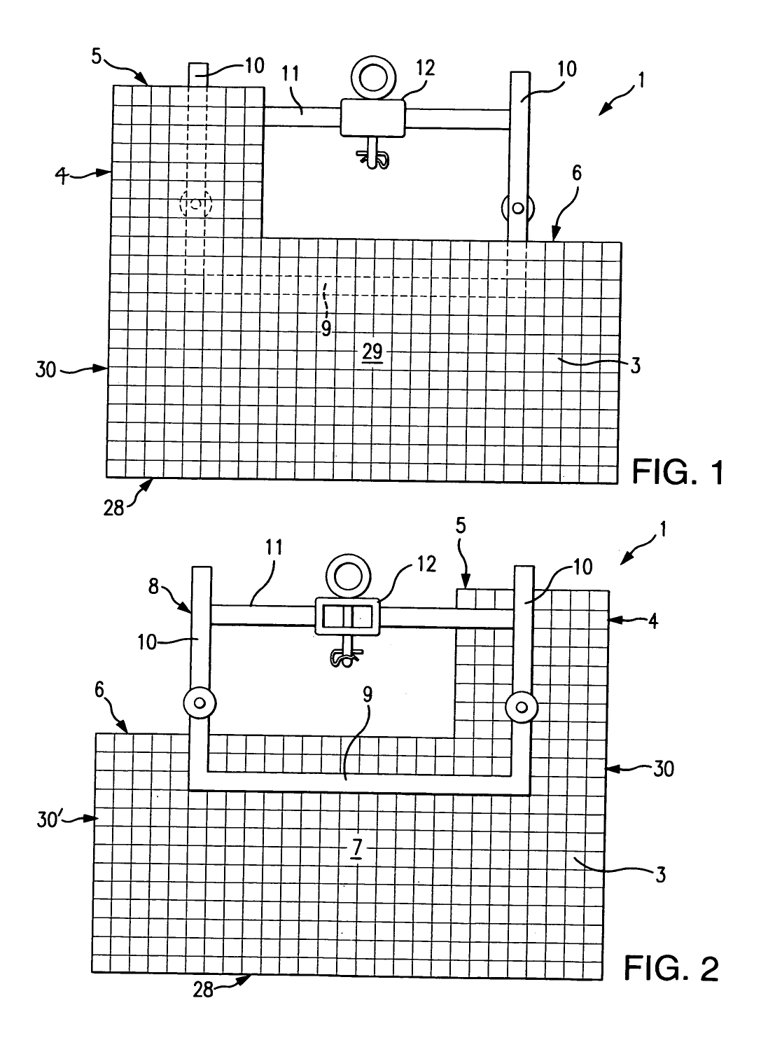

FIG. 1 is a full side view of a device 1 of this invention showing the mounting bracket 2 on the opposite side of the device 1. A detailed description of the mounting bracket 2 will be discussed infra with regard to FIG. 2.

The device 1 consists of metal wire mesh that is configured into a cage-like structure 3 having a top 6, a bottom 28, a front side, 7 a back side 29, and two ends 30 and 30′. The device 1 is designed to attach, temporarily, on the side of a fishing boat. The unique features of the device 1 are the extended portion 4, and the open top 5 of the extended portion 4. This feature allows one to essentially pitch a caught fish into the cage-like structure 3 without having to open a top 6 of the cage-like structure 3. The fact that the extended portion 4 is extended behind the top 6 of the cage-like structure 3 allows for a situation where the fish, once caught and placed into the cage, cannot escape from the cage-like structure, but allows for safe and easy retrieval of the fish once they are brought ashore.

Turning now to FIG. 2, there is shown mounted on the front side 7 of the cage-like structure 3 a mounting bracket 8 that is used to attach the device 1 to the side 32 of a fishing boat. The mounting bracket 8 is manufactured from metal, and it consists of a framework consisting of a bottom rail 9, two side rails 10, and a cross member rail which is a top rail 11. At the top end of the mounting bracket 8, there is an L-shaped extension 31 that rests on the top edge of the side of a boat 32.

The top rail 11 has mounted on it, near the center thereof, an attachment bracket 12 for attaching the cage-like structure 3 to an oarlock receptacle 13 shown in FIG. 5. The attachment bracket 12 (see FIG. 4) consists of a housing 14 having a top 15 and a bottom 16. Openings 17 and 18 (shown in phantom) in both the top 15 and the bottom 16, that are aligned, provide for the insertion of an oar lock 19, and the oar lock 19, once inserted, has a retainer pin 20 inserted in an opening in the oar lock 19 to maintain the oarlock 19 in the openings 17 and 18.

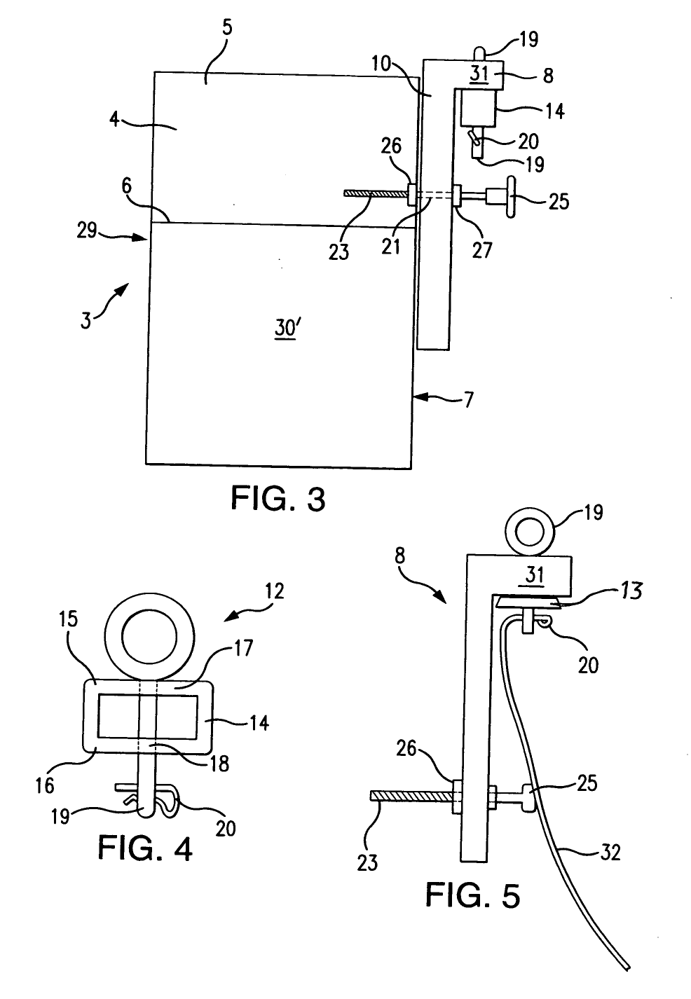

The mounting bracket 8 (see FIG. 3) has an opening 21 and 22 in each of the side rails 10 (opening 21 shown only in phantom) into which is inserted a stand-off rod 23 and 24 (also see FIG. 3, only 23 is shown in phantom) for holding the cage-like structure 3 essentially vertical along the side of a fishing boat. The stand-off rods 23 and 24 each have a distal end to which is attached an enlarged portion 25 that actually touches the side of the boat. The stand-off rods 23 and 24 are manufactured from threaded rod, and are mounted in the openings 21 and 22 by using nuts 26 and 27 on the rods on both sides of the side rails 10. In this manner, the stand-off rods 23 and 24 are adjustable to provide the proper distance of stand-off from the boat side to make the cage-like structure 3 nearly vertical with regard to the side of the boat.

The mounting bracket 8 is attached to the cage-like structure 3 by bolts or welding or some other convenient means, welding being shown in the Figures.

The fish basket of this invention has the benefits of convenience of placing fish in the basket and easy and quick retrieval of the fish from the basket, stability of the cage-like structure 3 when the boat is moving such as when trolling for fish (all other devices drag in the water and eventually kill the fish). In addition, one does not have to open the top of the basket to insert fish. In addition, when the basket if retrieved and placed on a solid substrate, it does not collapse like the prior art baskets do.

It has been observed in use, that when fish are placed in the basket, they tend to swim along with the movement of the boat which indicates that they would survive if placed back into the water. Thus, an added advantage is the capability of being able to put the fish back into the lake or stream and they will survive.

What is claimed is:

1. A stabilized fish basket, said stabilized fish basket comprising:
a. a metal wire mesh enclosure having essentially a cage-like structure with a top, bottom, front side, back side, and two ends;
b. said cage-like structure having a portion near one end that is extended above said cage-like structure but is unitary therewith, said extended portion having an open top;
c. a mounting structure fixedly attached to one side of said cage-like structure said mounting structure comprising a metal framework consisting of a bottom rail, two side rails, and a cross member rail forming a top rail;
said top rail having mounted thereon near the center thereof, an attachment bracket for attaching said cage-like structure to an oar lock receptacle on a boat, said attachment bracket consisting of a housing having a top and a bottom;
there being aligned openings through said top and said bottom through which there is inserted an oar lock having a retainer pin for retaining said oar lock in said oar lock receptacle;
each said side rail having an adjustable stand-off rod mounted therein for holding said cage-like structure essentially vertical along the side of a boat.
